(19) United States
(12) Patent Application Publication
(10) Pub. No.: US 2025/0218714 A1
(43) Pub. Date: Jul. 3, 2025

(54) OPERATING MECHANISM AND ELECTRICAL DEVICE

(71) Applicant: Schneider Electric (China) Co., Ltd., Beijing (CN)

(72) Inventors: Zhenyao Gong, Shanghai (CN); Xuedong Xia, Shanghai (CN); Yuchen Ye, Shanghai (CN)

(73) Assignee: Schneider Electric (China) Co., Ltd., Beijing (CN)

(21) Appl. No.: 18/427,903

(22) Filed: Jan. 31, 2024

(30) Foreign Application Priority Data
Jan. 3, 2024 (CN) 202410010699.3

(51) Int. Cl. H01H 50/36; H01H 50/64

(52) U.S. Cl. CPC H01H 50/36; H01H 50/641

(57) ABSTRACT

The present disclosure provides an operating mechanism, which includes: a stationary contact, a movable contact assembly, a push rod, a connection piece moving together with the movable contact assembly, and a magnetic core. The push rod includes a hook part, which is in place between the first abutting part and the second abutting part, upon the second abutting part of the magnetic core exerting a force in the first direction on the hook part, the hook part is able to avoid from the in place position, so that the first abutting part and the second abutting part directly abut against each other. Upon the hook part being in place, the push rod is able to drive the connection piece and the movable contact assembly to move; upon the hook part avoiding, the magnetic core is able to drive the connection piece and the movable contact assembly to move.

### TECHNICAL FIELD

The present disclosure relates to the electrical field, in particular to an operating mechanism and an electrical device comprising the operating mechanism.

### BACKGROUND

The mechanical tripping of solid-state miniature circuit breaker (SSMCB) is different from that of traditional miniature circuit breaker (MCB), and the disconnecting and closing operation of isolating contacts can be realized by buttons, and at the same time, the solid-state miniature circuit breaker has the function of automatic disconnecting and closing operation. When the overload or short circuit fault occurs in the product, the MOSFET electronic components are disconnected first, and then the isolating contacts are disconnected, so that the product does not generate electric arc and the tripping time is short.

However, the existing solid-state miniature circuit breaker may have potential safety hazards, and the disconnecting and closing operation of manually pressing the button and automatic disconnecting and closing operation functions cannot be carried out at the same time. For example, if the button is pressed by a human hand, at the same time, there is a fault in the product and it needs to be tripped, but the isolating contacts cannot be automatically tripped (trip free) due to the manual pressing, so there are certain risks and hazards. Therefore, it is needed to provide further safety protection for the situation that the button is pressed by a human hand and there is an internal fault at the same time, so that when the button is pressed by a human hand, the isolating contacts can also perform automatic tripping operation.

### SUMMARY

The purpose of the present disclosure is to at least solve the shortcomings existing in the prior art. The present disclosure provides an operating mechanism, which includes: a movable contact assembly, being movable in a first direction and a second direction opposite to the first direction relative to the stationary contact; a connection piece, moving together with the movable contact assembly, the connection piece including a first abutting part facing the second direction; a magnetic core, including a second abutting part facing the first direction and capable of being electrically driven to move in the first direction; a push rod, comprising a hook part, wherein the hook part is configured to in place between the first abutting part and the second abutting part, upon the second abutting part of the magnetic core exerting a force in the first direction on the hook part, the hook part is movable away from a position between the first abutting part and the second abutting part, so that the first abutting part and the second abutting part directly abut against each other.

Upon the hook part being in place between the first abutting part and the second abutting part, the connection piece and the movable contact assembly are drivable by the push rod to move in the first direction through abutting between the hook part and the first abutting part; upon the first abutting part and the second abutting part abutting directly, the connection piece and the movable contact assembly are drivable by the magnetic core to move in the first direction.

According to some embodiments of the present disclosure, the movable contact assembly moves among a closed position in which the movable contact assembly contacts with the stationary contact, a disconnecting position in which the movable contact assembly separates from the stationary contact and a reset position in which the movable contact assembly triggers a reset piece, and the disconnecting position, the closed position and the reset position are sequentially arranged in the first direction, and upon being triggered, the reset piece actuates the movable contact assembly to move to the disconnecting position in the second direction.

According to some embodiments of the present disclosure, the push rod includes a columnar body extending along a first direction and a hook part transverse to the columnar body, the columnar body includes a central axis along the first direction, the hook part is connected with an elastic piece so that the hook part is movable towards or away from the central axis relative to the columnar body, and the hook part is biased by the elastic piece at a biased position where the hook part protrudes from the columnar body away from the central axis, the connection piece is arranged upstream of the movable contact assembly and downstream of the push rod, in the first direction, the magnetic core is arranged upstream of the connection piece in the first direction, so that the first abutting part and the second abutting part are arranged opposite to each other in the first direction, upon being in the biased position, the hook part is located between the first abutting part and the second abutting part in the first direction, upon the second abutting part exerting a force in the first direction on the hook part, the hook part is movable towards the central axis, and then the first abutting part abuts against the second abutting part.

According to some embodiments of the present disclosure, the hook part includes a first surface facing the stationary contact and a second surface opposite to the first surface, wherein, upon the push rod being actuated to move in the first direction, the first surface abuts against the first abutting part to drive the connection piece and the movable contact assembly to move together in the first direction, upon being driven by electricity to move in the first direction to actuate the second abutting part to abut against the second surface, the magnetic core exerts a force in the first direction to the second surface, so that the hook part moves towards the central axis, and then the first abutting part abuts against the second abutting part.

According to some embodiments of the present disclosure, the second surface is inclined relative to the first surface, so that, upon a force in a first direction being applied to the second surface, the elastic piece is deformed to cause the hook part to move toward the central axis.

According to some embodiments of the present disclosure, upon the first abutting part and the second abutting part abutting against each other, a gap along the first direction is provided between the first abutting part and the second abutting part at a side facing the hook part, so that, upon a force between the first abutting part and the second abutting part being lower than a threshold value, the hook part is configured be biased back to the biased position and located between the first abutting part and the second abutting part.

According to some embodiments of the present disclosure, the connection piece includes a first channel extending from the first abutting part in the first direction, and the magnetic core includes a second channel extending from the second abutting part in the second direction, and the push rod is at least partially inserted into the second channel in the first direction, so that, upon the hook part being in the biased position, the hook part is located between the first abutting part and the second abutting part in the first direction, and, upon the hook part moving towards the central axis and leaving the biased position, the hook part is configured to be located in the first channel or the second channel.

According to some embodiments of the present disclosure, a first end of the push rod close to the stationary contact in the first direction is provided with an elastic arm, the elastic arm is swingable towards or away from the central axis relative to the columnar body, and the hook part is arranged at a free end of the elastic arm and biased by the elastic arm to protrude from the columnar body away from the central axis.

According to some embodiments of the present disclosure, the second surface is inclined relative to the first surface, so that upon a force in a first direction being applied to the second surface, the elastic arm is deformed to swing toward the central axis.

According to some embodiments of the present disclosure, the elastic arm extends from the first end of the push rod away from the stationary contact and obliquely relative to the columnar body, and the columnar body is provided with an accommodating opening corresponding to the elastic arm to allow the elastic arm to be accommodated upon the elastic arm swinging toward the central axis.

According to some embodiments of the present disclosure, two elastic arms are symmetrically arranged relative to the central axis.

According to some embodiments of the present disclosure, the connection piece further includes a first section and a second section which are sequentially arranged along the second direction, the first section is internally provided with a first channel along the first direction; the second section is internally provided with an accommodating channel being communicated with the first channel; and the second section includes a blocking part protruding towards the central axis, and the push rod is at least partially inserted into the accommodating channel along the first direction, and the blocking part is configured to abut against the second surface of the hook part to prevent the push rod from departing from the connection piece.

According to some embodiments of the present disclosure, at least a part of the second section extends into the second channel in the second direction, and the accommodating channel is partially open to the second channel in a circumferential direction around the central axis.

According to some embodiments of the present disclosure, a second end of the push rod, which is opposite to the first end, protrudes, in the second direction, from an end face of the magnetic core farthest from the stationary contact, and the second end drivable by an external force to actuate the push rod to move in the first direction.

According to some embodiments of the present disclosure, the operating mechanism further includes a stopper, arranged upstream of the second end in the first direction to limit a movement stroke of the push rod in the second direction.

The present disclosure further provides an electrical device, which includes any one of the abovementioned operating mechanisms.

According to some embodiments of the present disclosure, the electrical device is a solid-state miniature circuit breaker.

### BRIEF DESCRIPTION OF DRAWINGS

FIG. 1 shows a schematic cross-sectional view of an operating mechanism according to an embodiment of the present disclosure, in which a movable contact assembly is in a disconnected state;

FIG. 2 shows a schematic perspective view of a push rod in the operating mechanism according to FIG. 1;

FIG. 3 shows a schematic perspective view of a connection piece in the operating mechanism according to FIG. 1;

FIG. 4A shows a schematic perspective view of a magnetic core in the operating mechanism according to FIG. 1;

FIG. 4B shows a plan view of a magnetic core in the operating mechanism according to FIG. 1 as viewed in a second direction;

FIG. 4C shows a schematic cross-sectional view of the magnetic core taken from M-M shown in FIG. 4B;

FIG. 5A shows a schematic cross-sectional view of an operating mechanism according to an embodiment of the present disclosure, wherein the operating mechanism is in a manually closing state;

FIG. 5B shows a partial enlarged view of relative positions of the first abutting part, the second abutting part and the hook part of the operating mechanism in FIG. 5A;

FIG. 6A shows a schematic cross-sectional view of an operating mechanism according to an embodiment of the present disclosure, wherein the operating mechanism is in an automatic closing state;

FIG. 6B shows a partial enlarged view of relative positions of the first abutting part, the second abutting part and the hook part of the operating mechanism in FIG. 6A;

FIG. 7A shows a schematic cross-sectional view of an operating mechanism according to an embodiment of the present disclosure, wherein the operating mechanism is in an automatic tripping state;

FIG. 7B shows a partial enlarged view of relative positions of the first abutting part, the second abutting part and the hook part of the operating mechanism in FIG. 7A.

### LIST OF REFERENCE NUMERALS

1—push rod, 10—cylindrical body, 11—first end, 12—second end, 13—elastic arm, 14—hook part, 141—first surface, 142—second surface, 15—accommodating opening
2—connection piece, 21—first section, 211—first abutting part, 212—first channel, 22—second section, 221—accommodating channel, 222—blocking part
3—magnetic core, 31—second abutting part, 32—second channel, 33—end face
4—Movable contact assembly
A—central axis
D1—first direction, D2—second direction

### DETAILED DESCRIPTION

In order to make the purpose, scheme and advantages of the technical scheme of the present disclosure clearer, the technical scheme of the embodiment of the present disclosure will be described clearly and completely with the accompanying drawings of specific embodiments of the present disclosure. Unless otherwise specified, the terms used herein have the ordinary meaning in the art. Like reference numerals in the drawings represent like parts.

In the description of the present disclosure, it should be noted that unless otherwise specified and limited, the terms “installation”, “connection” and “connecting” should be broadly understood, for example, it can be fixed connection, detachable connection or integrated connection; it can be mechanical connection or an electrical connection; it can be direct connection, or can also be indirect connection through an intermediate medium, and can be the internal connection between two elements. For those skilled in the art, the specific meanings of the above terms in the present disclosure can be understood in specific situations.

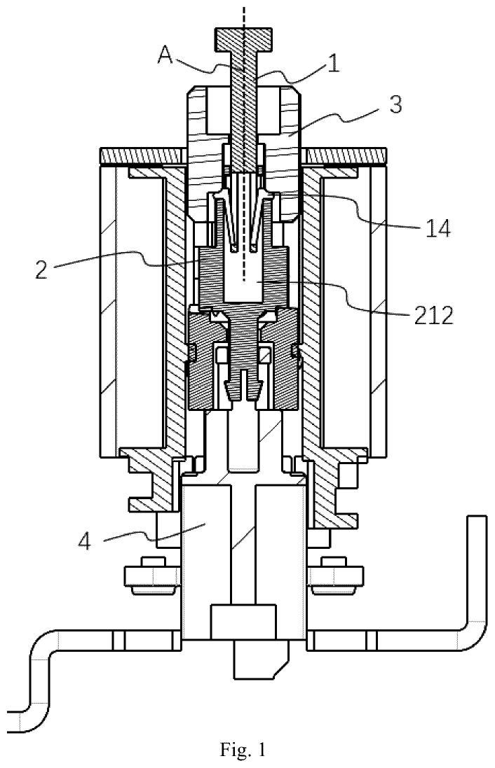

For convenience of explanation, in the present disclosure, the direction in which the disconnecting position of the movable contact assembly points to the closed position is designated as the first direction D1, and the direction opposite to the first direction D1 is designated as the second direction D2, as illustrated by FIG. 1.

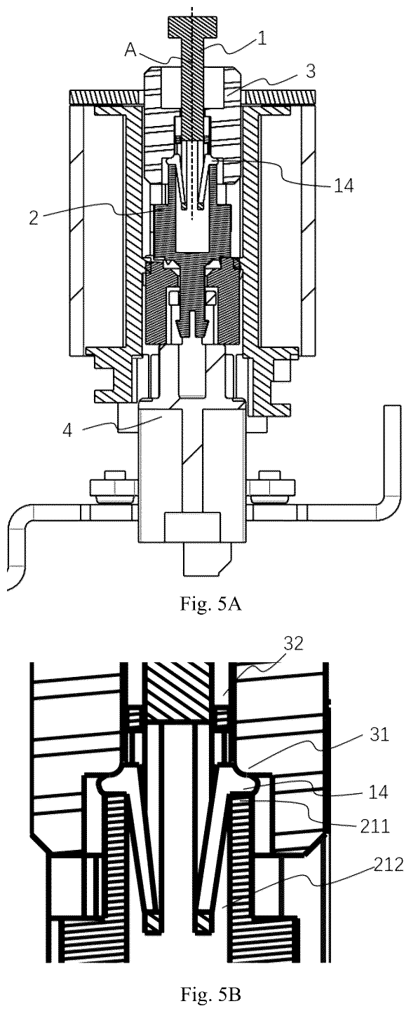

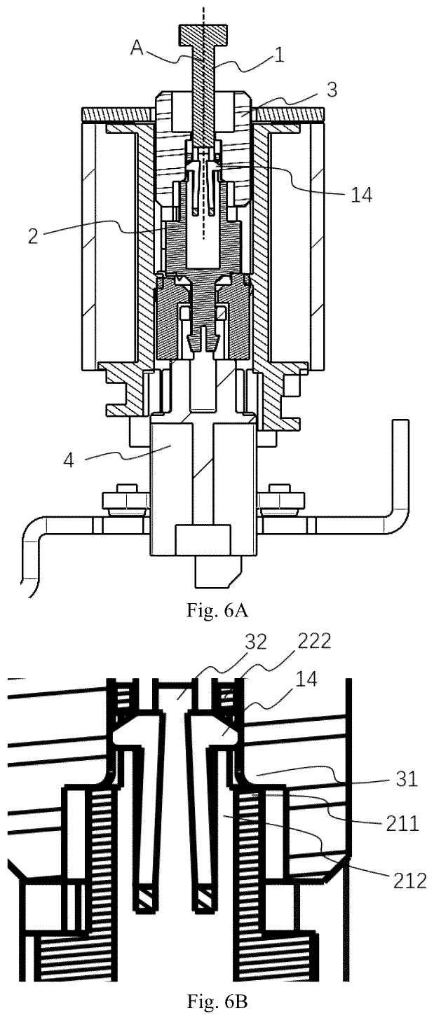

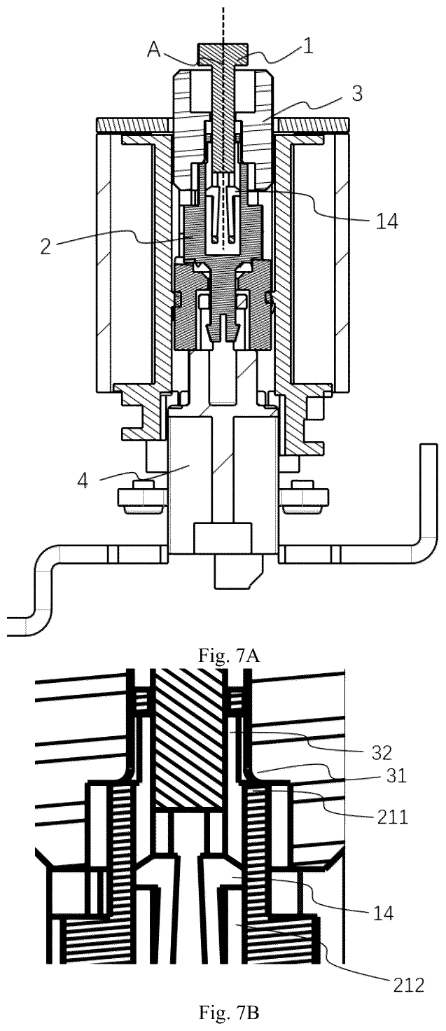

FIG. 1 shows a schematic cross-sectional view of an operating mechanism according to an embodiment of the present disclosure, in which a movable contact assembly 4 is in a disconnecting state. As illustrated by FIG. 1, the operating mechanism includes a stationary contact (not shown) and a movable contact assembly 4, the stationary contact is arranged downstream of the movable contact assembly 4 along the first direction D1, and the movable contact assembly 4 is provided with the movable contact, and the circuit is turned on and off through the contact and separation between the movable contact and the stationary contact. According to the present disclosure, the movable contact assembly 4 can move in the first direction D1 and the second direction D2 relative to the stationary contact, thereby realizing movement among a closed position (the position of the movable contact assembly 4 shown in FIGS. 5A and 6A), a disconnecting position (the position of the movable contact assembly 4 shown in FIGS. 1 and 7A) and a reset position. In the closed position, the movable contact assembly 4 contacts with the stationary contact, and the circuit is turned on; in the disconnecting position, the movable contact assembly 4 is separated from the stationary contact, and the circuit is turned off. The disconnecting position, the closing position and the reset position are sequentially arranged along the first direction.

Hereinafter, the reset position will be described, which is located downstream of the closed position in the first direction. The reset position can be reached when the movable contact assembly 4 moves further in the first direction D1 from the closed position. The operating mechanism according to the present disclosure further includes a reset piece (not shown) arranged downstream of the movable contact assembly 4 in the first direction. When the movable contact assembly 4 moves to the reset position, the reset piece is triggered to actuates the movable contact assembly 4 to move to the disconnecting position in the second direction D2.

Therefore, the closing operation between the movable contact and the stationary contact can be realized by moving the movable contact assembly 4 in the first direction D1, and the disconnecting operation between the movable contact and the stationary contact can also be realized by moving the movable contact assembly 4 in the first direction D1. Furthermore, the closing operation and the disconnecting operation can be realized only by driving in one direction (the first direction D1), regardless of manual pressing driving or electrical driving.

In order to ensure the stability of operation, the operating mechanism according to the present disclosure is provided with a position holding mechanism. When the movable contact assembly 4 moves from the disconnecting position to a position over the closing position in the first direction D1, the movable contact assembly 4 is held in place in the closed position by the position holding mechanism, without being triggered by the reset piece to move back to the disconnecting position in the second direction D2, thereby ensuring the stability of the closing operation of the movable contact and the stationary contact. Only when the movable contact assembly 4 is held in the closed position and moves from the closed position to the reset position in the first direction D1, the movable contact assembly 4 can be triggered by the reset piece to move back to the disconnecting position in the second direction D2. The function of the position holding mechanism is known in the prior art and understood by those skilled in the art, and its specific implementation is not the focus of the present disclosure, so it will not be further developed in detail.

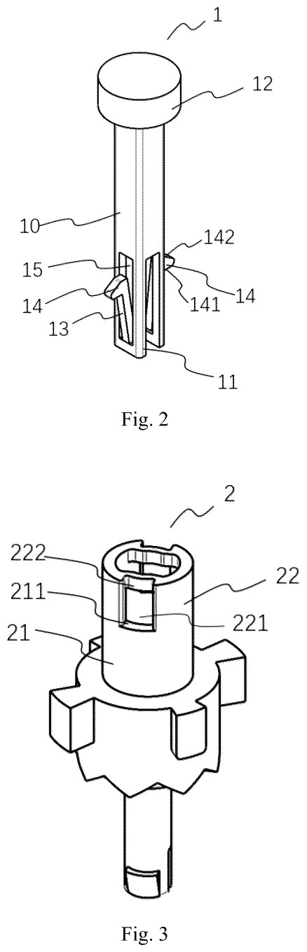

As illustrated by FIG. 1, the operating mechanism according to the present disclosure further includes a push rod 1, and FIG. 2 shows a perspective schematic view of the push rod 1 in the operating mechanism according to FIG. 1. The push rod may include a cylindrical body 10 extending in a first direction D1, which includes a central axis A along the first direction D1. The end of the push rod 1 close to the stationary contact in the first direction D1 is a first end 11, and the end opposite to the first end 11 is a second end 12. The first end 12 may be provided with a hook part 14 transverse to the cylindrical body 10, and the hook part 14 is connected with an elastic piece so that the hook part 14 can move toward or away from the central axis A relative to the cylindrical body 10. And the hook part 14 is biased by the elastic piece at a biased position in which the hook part 14 protrudes from the cylindrical body 10 away from the central axis A. The second end can be actuated by an external force (for example, a person pressing) to cause the push rod 1 to move in the first direction D1.

For example, the elastic piece may be a spring or torsion spring connected to the hook part 14, or an elastic arm 13 as illustrated by FIG. 2, and both ends of the elastic arm 13 are connected to the cylindrical body 10 and the hook part 14 respectively. Specifically, the elastic arm 13 can swing toward or away from the central axis A relative to the cylindrical body 10, and the hook part 14 is arranged at a free end of the elastic arm 13, for example, the hook part 14 can extend away from or toward the stationary contact from the cylindrical body 10. Thereby, the hook part 14 is driven to move toward or away from the central axis A with respect to the columnar body 10. The elastic arm 13 is biased to protrude from the columnar body 10 away from the central axis A, and thus the hook part 14 is also biased to protrude from the columnar body 10 away from the central axis A.

The hook part 14 includes a first surface 141 facing the stationary contact and a second surface 142 opposite to the first surface 141, and the second surface 142 is configured to move the hook part 14 towards the central axis A when the second surface 142 receives a force in the first direction D1. For example, the second surface 142 may be a curved surface or an inclined surface as illustrated by FIG. 2, so that the force received in the first direction D1 can be decomposed into a component force toward the central axis A, so that the hook part 14 can move from the biased position toward the central axis A. On the other hand, the first surface 141 is configured to receive a force in the second direction D2 without causing or hardly causing the hook 1 to move toward or away from the central axis A. Therefore, as described later, the push rod 1 drives the connection piece 2 to move in the first direction D1 through the first surface 141 abutting against the first abutting part 221, and when the second abutting part 31 abuts against the second surface 142 and exerts a force, the second abutting part 31 actuates the hook part 14 to move towards the central axis A, thus realizing the “avoidance” function of the hook part.

Further, the elastic arm 13 extends obliquely from the first end 11 of the push rod 1 away from the stationary contact with respect to the columnar body 10. As illustrated by FIG. 2, the columnar body 10 is provided with an accommodating opening 15 corresponding to the elastic arm 13 to allow the elastic arm 13 to be accommodated when the elastic arm 13 swings toward the central axis A. This oblique arrangement away from the stationary contact makes the elastic arm 13 bear greater force in the second direction, that is, a greater driving force can be transmitted through the first surface 141, to drive the connection piece 2, and the structure is more compact. The arrangement of the accommodating opening 15 allows the elastic arm 13 to undergo greater swing deformation toward the central axis A.

In addition, a plurality of elastic arms 13 can be provided, for example, two elastic arms 13 are provided as illustrated by FIG. 2, to bear greater force, and the plurality of elastic arms share the force to increase the service life of the push rod and reduce the stress strength requirement. In particular, a plurality of arms are symmetrically arranged about the central axis A, thereby more evenly sharing the force and making the load more uniform.

As illustrated by FIG. 1, the operating mechanism according to the present disclosure further includes a connection piece 2, and FIG. 3 shows a perspective schematic view of the connection piece 2 in the operating mechanism according to FIG. 1. The connection piece 2 is arranged upstream of the movable contact assembly 4 and downstream of the push rod 1 in the first direction D1, and is connected with the movable contact assembly 4 to move together, especially in the first direction D1 and the second direction D2. The connection piece 2 includes a first abutting part facing the second direction D2, as illustrated by FIG. 3.

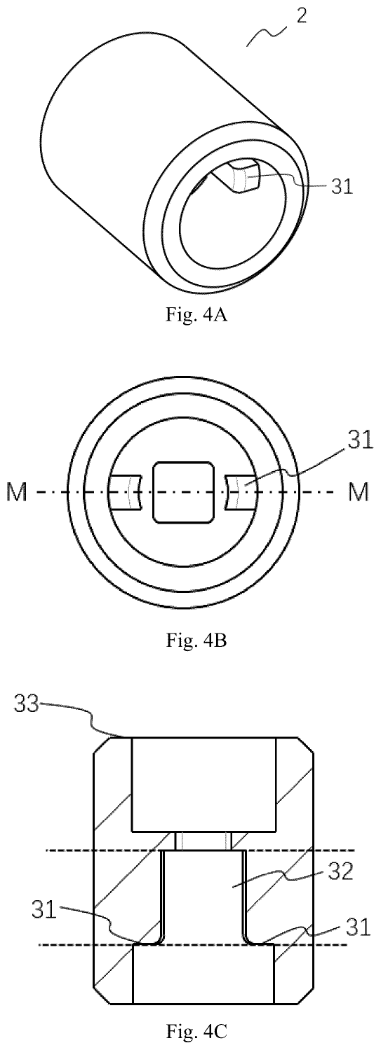

As illustrated by FIG. 1, the operating mechanism according to the present disclosure further includes a magnetic core 3, and FIG. 4A shows a perspective schematic view of the magnetic core 3 in the operating mechanism according to FIG. 1; FIG. 4B shows a plan view of the magnetic core 3 in the operating mechanism according to FIG. 1 as viewed in the second direction; FIG. 4C shows a schematic cross-sectional view of the magnetic core 3 taken from M-M shown in FIG. 4B. The magnetic core 3 can be electrically driven to move in the first direction D1. The magnetic core 3 is arranged upstream of the connection piece 2 in the first direction D1, so that the magnetic core 3 can move toward the connection piece 2. The magnetic core 3 also includes a second abutting part 31 facing the first direction D1, so that the first abutting part 211 and the second abutting part 31 are arranged to face each other in the first direction, as illustrated by FIG. 1.

As illustrated by FIG. 1, the push rod 1, the connection piece 2 and the magnetic core 3 are configured to be located between the first abutting part 211 and the second abutting part 31 in the first direction D1 when the hook part 14 is in the biased position. Therefore, when the push rod 1 is actuated to move in the first direction D1 by an external force (for example, pressed by a person) as described above, the first surface 141 abuts against the first abutting part 211 to drive the connection piece 2 and the movable contact assembly 4 to move together in the first direction D1. According to this arrangement, when the magnetic core 3 is electrically driven to move in the first direction D1 as described above to actuate the second abutting part 31 to abut against the second surface 142, a force in the first direction D1 is applied to the second surface 142, so that the hook part 14 moves towards the central axis A to realize “avoidance”, and then the first abutting part 211 abuts against the second abutting part 31. Because the first abutting part 211 abuts against the second abutting part 31, the force in the first direction D1 or the second direction D2 can be transmitted between the connection piece 2 and the magnetic core 3, thus the magnetic core 3, the connection piece 2 and the movable contact assembly 4 can move together in the first direction D1 or the second direction D2. Thus, manual closing operation, manual disconnecting operation, automatic closing operation, automatic disconnecting operation and automatic tripping operation can be realized, which will be described in detail in the following with reference to FIGS. 5A-7B.

Further, the first abutting part 211 is an arc-shaped wall as illustrated by FIG. 3, which includes an abutting surface facing the second direction, and the second abutting part 31 may be a protruding rib as illustrated by FIGS. 4A and 4B, which includes an abutting surface facing the first direction. The present disclosure is not limited to the first abutting part 211 and the second abutting part 31, and both of them may be other types of abutting parts, such as fingers, tabs, ends, steps, flanges, etc., as long as they include surfaces opposite to each other for abutting.

Further, when the first abutting part 211 abuts against the second abutting part 31, there is a gap along the first direction between the first abutting part 211 and the second abutting part 31 at the side facing the hook part 14, as illustrated by FIGS. 6B and 7B. This gap is beneficial to make the first abutting part 211 and the second abutting part 31 separate from each other by the elastic force exerted by the hook part 14 at this gap when the acting force between the first abutting part 211 and the second abutting part 31 is lower than the threshold value, and thus the hook part 14 is biased back to the biased position and located between the first abutting part and the second abutting part. For example, the gap can be realized by providing one or both of the first abutting part 211 and the second abutting part 31 with a rounding or chamfering at the side facing the hook part 14. As illustrated by FIGS. 6B and 7B, the second abutting part 31 has a rounded structure, thereby forming a gap along the first direction D1 there. Therefore, the hook part 14 can be reset to the biased state from the “avoidance” state, so as to be in place between the first abutting part 211 and the second abutting part 31, especially to ensure that the hook part 14 is always in place between the first abutting part 211 and the second abutting part 31 when the movable contact assembly 4 is in the disconnecting state, as described later.

Further, returning to FIG. 3, the connection piece 2 may further include a first section 21, in which a first channel 212 along the first direction D1 is internally provided, and the first channel extends from the first abutting part 221 along the first direction D1, as illustrated by FIG. 1. The magnetic core 3 includes a second channel 32 extending from the second abutting part 31 in a second direction D2, as illustrated by FIG. 4C. Therefore, the push rod 1 provided with the hook part 14 can be accommodated in the first channel 211 and/or the second channel 32, specifically, the push rod 1 is at least partially inserted into the second channel 32 along the first direction D1, so that the transformation of the relative states and the assembly of the push rod 1, the connection piece 2 and the magnetic core 3 can be realized. In particular, the hook part 14 can be inserted into the first abutting part 221 and the second abutting part 31 from the junction of the first channel 211 and the second channel 32 in the first direction D1, so as to position the hook part 14 between the first abutting part 221 and the second abutting part 31 in the first direction D1 when the hook part 14 is in the biased position. The hook part 14 can move away from the biased position from the junction of the first channel 211 and the second channel 32 in the first direction D1 from a position between the first abutting part 221 and the second abutting part 31 towards the central axis A, so as to realize “avoidance”; when the hook part 14 is in the “avoidance” state (moving away from the biased position toward the central axis), the hook part 14 can move in the first channel or the second channel to realize the movement of the push rod 1 relative to the connection piece 2 and the magnetic core 3. In addition, the structure that the push rod 1 can be accommodated in the first channel 211 and/or the second channel 32 makes the operating mechanism more compact and saves space.

In addition, the connection piece 2 may further include a second section 22, the first section 21 and the second section 22 are sequentially arranged along the second direction D2, and an accommodating channel 221 being communicated with the first channel 212 is provided inside the second section 22, and the second section 22 includes a blocking part 222 protruding toward the central axis A. As illustrated by FIG. 1, the push rod 1 is at least partially inserted into the accommodating channel 221 in the first direction, and the blocking part 222 protrudes toward the central axis A to such an extent that when the blocking part 222 abuts against the second surface 142 of the hook part 14, the push rod 1 can be prevented from departing from the connection piece 2. Therefore, the complete separation of the push rod 1 and the connection piece 2 is prevented, which leads to the failure of the operating mechanism.

In particular, at least a part of the second section 22 extends into the second channel 32 in the second direction D2, as illustrated by FIG. 1. The accommodating channel 221 is partially cut off in the circumferential direction around the central axis A to be open to the outside, especially to the second channel 32, as illustrated by FIGS. 1 and 3. Thus, a space for the second abutting part 31 to abut against the first abutting part 211 in the first direction is provided, and it is beneficial to simplify the assembly of the connection piece 2 and the magnetic core, and at the same time ensures that the first abutting part 211 and the second abutting part 31 are aligned in the first direction to prevent the first abutting part 211 and the second abutting part 31 from moving relative to each other in the circumferential direction.

As illustrated by FIG. 4C, the magnetic core 3 is penetrated in the first direction D1, and the second channel 32 is a section of the through hole. For convenience of explanation, two dotted lines are shown in FIG. 4C, and the second channel 32 is a section between the two dotted lines, so that the push rod 1 can be inserted into the second channel in the first direction D1. In addition, the second end 12 of the push rod 1, which is opposite to the first end 11, protrudes, in the second direction, from the end face 33 of the magnetic core 3 farthest from the stationary contact, thereby ensuring that the second end 12 can always be actuated by an external force, thereby causing the push rod 1 to move in the first direction.

In addition, the operating mechanism according to the present disclosure further includes a stopper (not shown) arranged upstream of the second end 12 in the first direction D1 to limit the movement stroke of the push rod in the second direction D2, thereby further defining the disconnecting position of the movable contact assembly 4. Specifically, it is ensured that when the reset piece is triggered, the limit position of the movement of the push rod 1 in the second direction D2is limited, and the movable contact assembly 4 can be further limited in the disconnecting position by limiting the limit position of the push rod 1 through the cooperation of the connection piece 2.

Hereinafter, with reference to FIGS. 5A-7B, how the movement processes of manual closing operation, manual disconnecting operation, automatic closing operation, automatic disconnecting operation and automatic tripping operation are realized by the operating mechanism according to the present disclosure will be described in detail. FIG. 5A shows a schematic cross-sectional view of an operating mechanism according to an embodiment of the present disclosure, wherein the operating mechanism is in a manually closing state; FIG. 5B shows a partial enlarged view of the relative positions of the first abutting part 211, the second abutting part 31 and the hook part 14 of the operating mechanism in FIG. 5A; FIG. 6A shows a schematic cross-sectional view of an operating mechanism according to an embodiment of the present disclosure, the operating mechanism is in an automatic closing state; FIG. 6B shows a partial enlarged view of the relative positions of the first abutting part 211, the second abutting part 31 and the hook part 14 of the operating mechanism in FIG. 6A; FIG. 7A shows a schematic cross-sectional view of an operating mechanism according to an embodiment of the present disclosure, the operating mechanism is in an automatic tripping state; FIG. 7B shows a partial enlarged view of the relative positions of the first abutting part 211, the second abutting part 31 and the hook part 14 of the operating mechanism in FIG. 7A.

Manual closing operation is a process of moving from the disconnecting state shown in FIG. 1 to the manual closing state shown in FIG. 5A. This process is realized by manually actuating the push rod 1. In this case, the push rod 1 is actuated to move in the first direction D1, so that the first surface 141 abuts against the first abutting part 211, as illustrated by FIG. 5B, to drive the connection piece 2 to move in the first direction D1 together with the movable contact assembly 4.

Manual disconnecting operation is a process of moving from the manual closing state shown in FIG. 5A to the disconnecting state shown in FIG. 1. This process is also realized by manually actuating the push rod 1. In this case, the movable contact assembly 4 is in place in the closed position, and the push rod 1 is actuated to move in the first direction D1, so that the first surface 141 also abuts against the first abutment portion 211, as illustrated by FIG. 5B, to drive the connection piece 2 to move from the closed position to the reset position together with the movable contact assembly 4 in the first direction D1. Until the reset piece is triggered, the movable contact assembly 4 moves in the second direction D2, which in turn drives the connection piece 2 to move in the second direction D2. While the first surface 141 abuts against the first abutting part 211, the connection piece 2 moves together with the push rod 1 until the push rod 1 is stopped by the stopper, so that the operating mechanism returns to the disconnecting state shown in FIG. 1.

Automatic closing operation is a process of moving from the disconnecting state shown in FIG. 1 to the automatic closing state shown in FIG. 6A. This process is realized by electrically actuating the magnetic core 3. In this case, the magnetic core 3 is electrically actuated to move in the first direction D1, so that when the second abutting part 31 abuts against the second surface 142, a force in the first direction D1 is applied to the second surface 142, so that the hook part 14 moves towards the central axis A to realize “avoidance”, and then the first abutting part 211 abuts against the second abutting part 31, as illustrated by FIG. 6B. Because the first abutting part 211 abuts against the second abutting part 31, the magnetic core 3 drives the connection piece 2 and the movable contact assembly 4 to move together in the first direction D1 until the movable contact assembly 4 is in the closed position. In this case, the magnetic core 3 and the connection piece 2 move relative to the push rod 1, and the hook part 14 is located in the second channel 32, as illustrated by FIG. 6B. Due to the existence of the stopper 222, it will abut against the second surface 142, preventing the push rod 1 from being separated from the connection piece 2, thereby driving the push rod to move in the first direction D1 for a certain distance.

Automatic disconnecting operation is a process of moving from the automatic closing state shown in FIG. 6A to the disconnecting state shown in FIG. 1. This process is also realized by electrically actuating the magnetic core 3. In this case, the movable contact assembly 4 is in place in the closed position, and the first abutting part 211 abuts against the second abutting part 31, as illustrated by FIG. 6B. The magnetic core 3 is electrically actuated to move in the first direction D1, and then the magnetic core 3 drives the connection piece 2 and the movable contact assembly 4 to continue to move together in the first direction D1 from the position shown in FIG. 6B, in particular, the movable contact assembly 4 moves from the closed position to the reset position. As a result, the reset piece is triggered, and the movable contact assembly 4 moves in the second direction D2, thereby driving the connection piece 2 to move in the second direction D2. The first abutting part 211 abuts against the second abutting part 31, and the connection piece 2 moves together with the magnetic core 3 until the magnetic core 3 is limited and stopped. In this case, the push rod 1 moves relative to the connection piece 2 and the magnetic core 3, and the hook part 14 moves relative to the connection piece 2 and the magnetic core 3 to the above-mentioned gap between the first abutting part 211 and the second abutting part 31. At this time, because the connection piece 2 and the magnetic core 3 stop, the force between the first abutting part 211 and the second abutting part 31 is lower than the threshold value, and the elastic force exerted by the hook part 14 at this gap away from the central axis A can make the first abutting part 211 and the second abutting part 31 separate. Thus, the operating mechanism returns to the disconnecting state shown in FIG. 1. In particular, each time in the disconnected state, the hook part 14 can move relatively to the above-mentioned gap and the biasing force exerted by the elastic arm 13 ensures that the hook part 14 always returns to the position between the first abutting part 211 and the second abutting part 31 as illustrated by FIG. 1.

Automatic tripping operation is a process of moving from the manual closing state shown in FIG. 5A to the automatic tripping state shown in FIG. 7A. This process is realized by electrically actuating the magnetic core 3. In this case, the movable contact assembly 4 is in the closed position, and the push rod 1 is held in the position shown in FIG. 5A by hand pressing. The magnetic core 3 is electrically actuated to move in the first direction D1, so that when the second abutting part 31 abuts against the second surface 142, a force in the first direction D1 is applied to the second surface 142, so that the hook part 14 moves towards the central axis A to realize “avoidance”, and then the first abutting part 211 abuts against the second abutting part 31, as illustrated by FIG. 7B. Because the first abutting part 211 abuts against the second abutting part 31, the magnetic core 3 drives the connection piece 2 and the movable contact assembly 4 to move together in the first direction D1 from the position shown in FIG. 5A, especially, the movable contact assembly 4 moves from the closed position to the reset position. As a result, the reset piece is triggered, and the movable contact assembly 4 moves in the second direction D2, thereby driving the connection piece 2 to move in the second direction D2. The first abutting part 211 abuts against the second abutting part 31, and the connection piece 2 moves together with the magnetic core 3 until the magnetic core 3 is limited and stopped, thereby realizing the tripping. In this case, the push rod 1 is held in the position shown in FIG. 5A by hand, and the push rod 1 moves relative to the connection piece 2 and the magnetic core 3, so that the hook part 14 moves relatively to the first channel 212, as illustrated by FIG. 7B.

According to the present disclosure, an electrical device including any of the above-mentioned operating mechanisms is also proposed. In particular, the electrical device is a solid-state miniature circuit breaker.

It should be understood that the above description is intended to be illustrative rather than limiting. For example, the above embodiments (and/or aspects thereof) may be used in combination with each other. In addition, many modifications may be made to adapt a particular situation or material to the teachings of the present disclosure without departing from its scope. The functions or performances of various elements or modules described herein are only for illustration and are in no way restrictive, but only exemplary embodiments. Many other embodiments and modifications within the spirit and scope of the claims will be apparent to those skilled in the art after reading the above description. Therefore, the scope of the present disclosure should be determined with reference to the appended claims, along with the full scope of equivalents to which such claims are entitled.

In the appended claims, the terms “including” and “in which” are used as simple English equivalents of the corresponding terms “including” and “in which”. Furthermore, in the following claims, the terms “first”, “second” and “third” are only used as labels, and no numerical requirements are intended to be imposed on their objects.

1. An operating mechanism, comprising:
a stationary contact,
a movable contact assembly, being movable in a first direction and a second direction opposite to the first direction relative to the stationary contact,
a connection piece, moving together with the movable contact assembly, the connection piece comprising a first abutting part facing the second direction,
a magnetic core, comprising a second abutting part facing the first direction and capable of being electrically driven to move in the first direction,
a push rod, comprising a hook part, wherein the hook part is configured to be in place between the first abutting part and the second abutting part, the hook part is movable away from a position between the first abutting part and the second abutting part upon the second abutting part of the magnetic core exerting a force in the first direction on the hook part,, so that the first abutting part and the second abutting part directly abut against each other,
upon the hook part being in place between the first abutting part and the second abutting part, the connection piece and the movable contact assembly are drivable by the push rod to move in the first direction through the hook part abutting the first abutting part; upon the first abutting part and the second abutting part abutting directly, the connection piece and the movable contact assembly are drivable by the magnetic core to move in the first direction.

2. The operating mechanism according to claim 1, wherein,
the movable contact assembly moves among a closed position in which the movable contact assembly contacts with the stationary contact, a disconnecting position in which the movable contact assembly separates from the stationary contact and a reset position in which the movable contact assembly triggers a reset piece, the disconnecting position, the closed position and the reset position are sequentially arranged in the first direction, and upon being triggered, the reset piece actuates the movable contact assembly to move to the disconnecting position in the second direction.

3. The operating mechanism according to claim 1, wherein,
the push rod comprises a columnar body extending along a first direction and a hook part transverse to the columnar body, the columnar body comprises a central axis along the first direction, the hook part is connected with an elastic piece so that the hook part is movable towards or away from the central axis relative to the columnar body, and the hook part is biased by the elastic piece at a biased position where the hook part protrudes from the columnar body away from the central axis,
the connection piece is arranged upstream of the movable contact assembly and downstream of the push rod, in the first direction,
the magnetic core is arranged upstream of the connection piece in the first direction, so that the first abutting part and the second abutting part are arranged opposite to each other in the first direction,
upon being in the biased position, the hook part is located between the first abutting part and the second abutting part in the first direction,
upon the second abutting part exerting a force in the first direction on the hook part, the hook part is movable towards the central axis, and then the first abutting part abuts against the second abutting part.

4. The operating mechanism according to claim 3, wherein,
the hook part comprises a first surface facing the stationary contact and a second surface opposite to the first surface,
wherein, upon the push rod being actuated to move in the first direction, the first surface abuts against the first abutting part to drive the connection piece and the movable contact assembly to move together in the first direction,
upon being driven by electricity to move in the first direction to actuate the second abutting part to abut against the second surface, the magnetic core exerts a force in the first direction to the second surface, so that the hook part moves towards the central axis, and then the first abutting part abuts against the second abutting part.

5. The operating mechanism according to claim 4, wherein,
the second surface is inclined relative to the first surface, so that, upon a force in a first direction being applied to the second surface, the elastic piece is deformed to cause the hook part to move toward the central axis.

6. The operating mechanism according to any one of claim 3, wherein,
upon the first abutting part and the second abutting part abutting against each other, a gap along the first direction is provided between the first abutting part and the second abutting part at a side facing the hook part, so that, upon a force between the first abutting part and the second abutting part being lower than a threshold value, the hook part is configured to be biased back to the biased position and located between the first abutting part and the second abutting part.

7. The operating mechanism according to claim 6, wherein,
the connection piece comprises a first channel extending from the first abutting part in the first direction, the magnetic core comprises a second channel extending from the second abutting part in the second direction, and
the push rod is at least partially inserted into the second channel in the first direction, so that, upon the hook part being in the biased position, the hook part is located between the first abutting part and the second abutting part in the first direction,
upon the hook part moving towards the central axis and leaving the biased position, the hook part is configured to be located in the first channel or the second channel.

8. The operating mechanism according to claim 6, wherein,
a first end of the push rod close to the stationary contact in the first direction is provided with an elastic arm, the elastic arm is swingable towards or away from the central axis relative to the columnar body, the hook part is arranged at a free end of the elastic arm and biased by the elastic arm to protrude from the columnar body away from the central axis.

9. The operating mechanism according to claim 8, wherein,
the elastic arm extends from the first end of the push rod away from the stationary contact and obliquely relative to the columnar body, the columnar body is provided with an accommodating opening corresponding to the elastic arm to allow the elastic arm to be accommodated upon the elastic arm swinging toward the central axis.

10. The operating mechanism according to claim 8, wherein,
two elastic arms are symmetrically arranged relative to the central axis.

11. The operating mechanism according to claim 6, wherein,
the connection piece further comprises a first section and a second section which are sequentially arranged along the second direction, the first section is internally provided with a first channel along the first direction; the second section is internally provided with an accommodating channel being communicated with the first channel; and the second section comprises a blocking part protruding towards the central axis, and the push rod is at least partially inserted into the accommodating channel along the first direction, and the blocking part is configured to abut against the second surface of the hook part to prevent the push rod from departing from the connection piece.

12. The operating mechanism according to claim 11, wherein,
at least a part of the second section extends into the second channel in the second direction, and the accommodating channel is partially open to the second channel in a circumferential direction around the central axis.

13. The operating mechanism according to claim 5, wherein,
a second end of the push rod, which is opposite to the first end, protrudes, in the second direction, from an end face of the magnetic core farthest from the stationary contact, and the second end is drivable by an external force to actuate the push rod to move in the first direction.

14. The operating mechanism according to claim 13, further comprising:
a stopper, arranged upstream of the second end in the first direction to limit a movement stroke of the push rod in the second direction.

15. An electrical device, comprising an operating mechanism, comprising:
a stationary contact,
a movable contact assembly, being movable in a first direction and a second direction opposite to the first direction relative to the stationary contact,
a connection piece, moving together with the movable contact assembly, the connection piece comprising a first abutting part facing the second direction,
a magnetic core, comprising a second abutting part facing the first direction and capable of being electrically driven to move in the first direction,
a push rod, comprising a hook part, wherein the hook part is configured to be in place between the first abutting part and the second abutting part, the hook part is movable away from a position between the first abutting part and the second abutting part upon the second abutting part of the magnetic core exerting a force in the first direction on the hook part,, so that the first abutting part and the second abutting part directly abut against each other,
upon the hook part being in place between the first abutting part and the second abutting part, the connection piece and the movable contact assembly are drivable by the push rod to move in the first direction through the hook part abutting the first abutting part; upon the first abutting part and the second abutting part abutting directly, the connection piece and the movable contact assembly are drivable by the magnetic core to move in the first direction . . . .

16. The electrical device according to claim 15, wherein the electrical device is a solid-state miniature circuit breaker.

17. The electrical device according to claim 16, wherein,
the movable contact assembly moves among a closed position in which the movable contact assembly contacts with the stationary contact, a disconnecting position in which the movable contact assembly separates from the stationary contact and a reset position in which the movable contact assembly triggers a reset piece, the disconnecting position, the closed position and the reset position are sequentially arranged in the first direction, and upon being triggered, the reset piece actuates the movable contact assembly to move to the disconnecting position in the second direction.

18. The electrical device according to claim 16, wherein,
the push rod comprises a columnar body extending along a first direction and a hook part transverse to the columnar body, the columnar body comprises a central axis along the first direction, the hook part is connected with an elastic piece so that the hook part is movable towards or away from the central axis relative to the columnar body, and the hook part is biased by the elastic piece at a biased position where the hook part protrudes from the columnar body away from the central axis,
the connection piece is arranged upstream of the movable contact assembly and downstream of the push rod, in the first direction,
the magnetic core is arranged upstream of the connection piece in the first direction, so that the first abutting part and the second abutting part are arranged opposite to each other in the first direction,
upon being in the biased position, the hook part is located between the first abutting part and the second abutting part in the first direction,
upon the second abutting part exerting a force in the first direction on the hook part, the hook part is movable towards the central axis, and then the first abutting part abuts against the second abutting part.

19. The electrical device according to claim 18, wherein,
the hook part comprises a first surface facing the stationary contact and a second surface opposite to the first surface,
wherein, upon the push rod being actuated to move in the first direction, the first surface abuts against the first abutting part to drive the connection piece and the movable contact assembly to move together in the first direction,
upon being driven by electricity to move in the first direction to actuate the second abutting part to abut against the second surface, the magnetic core exerts a force in the first direction to the second surface, so that the hook part moves towards the central axis, and then the first abutting part abuts against the second abutting part.
